(19) United States
(12) Patent Application Publication
(10) Pub. No.: US 2008/0163057 A1
(43) Pub. Date: Jul. 3, 2008

(54) Method For Displaying Objects to be Positioned on a Display of a Positioning Device, a Positioning Device and an Application

(75) Inventors: Hannu Lohi, Kello (FI); Samuli Vanhala, Oulu (FI); Harri Piltonen, Varjakka (FI)

Correspondence Address: VOLPE AND KOENIG, P.C., UNITED PLAZA, SUITE 1600, 30 SOUTH 17TH STREET, PHILADELPHIA, PA, 19103, US

(73) Assignee: TRACKER OY, Oulunsalo (FI)

(21) Appl. No.: 11/912,359

(22) PCT Filed: Apr. 28, 2006
(86) PCT No.: PCT/FI2006/050174

§ 371 Date: Feb. 7, 2008

(30) Foreign Application Priority Data
Apr. 29, 2005 (FI) 20055204

(51) Int. Cl. G06F 3/00

(52) U.S. Cl. 715/718

(57) ABSTRACT

More than one object to be positioned can be set simultaneously in mobile satellite positioning devices, and these objects can be either fixed coordinate points or moving objects. The objects are shown as graphical symbols on the display of the positioning device. Positioning devices can be set in a map display mode, in which there is a map base depicting the area to be positioned visible on the display, or in an arrow display mode, in which there is a compass circle and a direction arrow pointing to the active object to be positioned visible on the display.

### FIELD OF INVENTION

The invention relates to a method for displaying objects to be positioned as graphical symbols on the display of a mobile positioning device, which can be set in a map display mode, in which there is a map base visible on the display, and in an arrow display mode, in which there is a compass circle and a direction arrow visible on the display. The invention also relates to an application for implementing the method in a positioning device, a positioning device and a computer program for loading the application into the memory of the positioning device.

### BACKGROUND

Mobile positioning devices utilizing satellite positioning have been developed for the determination of the location of various objects to be tracked. Satellite positioning is based on receiving signals transmitted by positioning satellites and calculating the location of the receivers on the basis of the distances of the satellites. The positioning devices on the commercial market use the satellite network of the Global Positioning System (GPS) of the USA.

In conventional satellite positioning devices, the satellite receiver has been placed inside the casing of the device. There are also solutions in which the satellite signal receiver is a separate part having a data transfer connection to a mobile terminal device provided with a positioning application. The data transfer connection can be a Bluetooth connection, for example. The terminal device can be, for example, a mobile phone, a palm computer or a portable computer, into the memory of which a suitable positioning application has been loaded. A positioning device then means a unit, which consists of a receiver, a terminal device and an application. There are also solutions in which the positioning device has no satellite signal receiver. In these solutions, the user indicates his location by means of a map shown on the display of the terminal device.

In the prior art positioning solutions, it is possible to set the device in different display modes, which have been designed to serve different situations of use. In the map display mode, there is a map base visible on the display of the positioning device, in which the user's own location, the location of the objects to be tracked and the location of the route points noted down are seen as graphical symbols. The part of the map shown on the display can be zoomed to the desired scale and rolled in different directions for showing the desired point in the terrain. In the prior art solutions, the user of the positioning device is generally shown in the middle of the map, and the map “moves” automatically to the right point according to the user's movements. The map display usually also includes data fields showing information wanted by the user, such as the user's direction of movement and the direction and distance to the selected object. In order to use the map display mode, there must naturally be a map of the area in question in the memory of the positioning device. In the arrow display mode, a compass circle and a direction arrow indicating the direction to the selected object are shown on the display of the positioning device. The data fields on the peripheral areas of the display show information wanted by the user, such as the speed of movement and the distance to the object. In addition, it is possible to set the display of the positioning device in one or more numerical modes, in which information about the direction of motion, speed, distances, altitude, distances covered, sunrise and sunset times etc. is shown as numerical values on the display of the positioning device.

Some positioning devices can also be set to track moving objects in addition to fixed ones. In that case, the object being tracked must have its own GPS receiver or some other device giving position information, such as a device based on the network positioning of a mobile phone, which has a data transfer connection to the positioning device used by the person tracking the object. In the prior art positioning devices, data transfer between the devices takes place via a GSM mobile communication network or a radio network. A special application of positioning devices tracking moving objects is a GPS positioning system intended for tracking hunting dogs. Such a system includes a Dog-GPS device fastened to the harness of the hunting dog and a Map-GPS device carried along by the hunter. The Dog-GPS device determines its location by satellite positioning and sends the information to the Map-GPS device as a text message. After this, the hunter sees the location of the dog in his own positioning device. The location information of the dog can be updated at desired intervals. The hunter can set the positioning device in the arrow display mode, in which the direction arrow shows in which direction the dog being tracked is.

There are many disadvantages in the prior art positioning devices and the applications used in them. The arrow display mode is generally used when clear guidance from one place to another is wanted. For example, at the end of the hunt the hunter can set the location of his car as the object on the map display and then switch to the arrow display mode. Then he will easily find the object by following the direction indicated by the direction arrow pointed towards the object. However, in the prior art positioning devices and applications, it is possible to set the guidance to only one object at a time in the arrow display mode. If the hunter has a dog equipped with a positioning device with him, the direction and distance of the dog from the hunter cannot be tracked on the arrow display at the same time as the direction arrow of the display is pointed to another object, e.g. the car. If the hunter also wants to see the direction and the distance to his dog or some other object while moving, he must repeatedly change the object to which the direction arrow guides on the positioning device. Changing the object always requires many key functions, and therefore it is slow and laborious. In addition, if the object of the guidance, such as the car, is not saved in the memory as a route point but has only been pointed on the map, the information of such a temporary object is lost when the object is changed, and it has to be reselected from the map. The problem is even more pronounced if there are more than two objects to be tracked.

In the map display mode, it is possible to set more than one fixed or moving objects to be tracked simultaneously in the prior art positioning devices and the applications in them. However, the objects are visible on the same map base only if they are sufficiently close to each other. If the objects cannot be visible on the same map base, the user of the positioning device gets no information of their location from the map. Naturally, all the objects being tracked can be made visible simultaneously when the scale of the map is sufficiently enlarged. However, then the value of the information given by the map is significantly reduced.

### SUMMARY

It is an objective of the invention to provide a method, an application to be loaded into the memory of a positioning device and a positioning device, by which the disadvantages related to showing more than one object to be positioned simultaneously on the display of the device can be significantly reduced.

The objectives of the invention are achieved by a method, positioning device and an application, which are characterized in what is set forth in the characterizing part of the independent claims. Some preferred embodiments of the invention are presented in the dependent claims.

It is a known fact that it is possible to set more than one objects to be positioned simultaneously in mobile positioning devices, and these objects can be fixed coordinate points or moving objects. The objects to be positioned are shown as graphical symbols on the display of the positioning device. The positioning devices can be set in a map display mode, in which a map base showing the area to be positioned is visible on the display. In this display mode, the objects to be positioned are shown as graphical symbols, which are placed at their correct location on the map base. The number of objects to be positioned that fit on the map base visible on the display depends on the mutual distance of the objects and the scale of the map base. The positioning devices can also be set in the arrow display mode, in which there is a compass circle and a direction arrow pointing to the active object to be positioned visible on the display. In the prior art positioning devices, the direction arrow only provides knowledge of the active object to be positioned. The basic idea of the method, positioning device and application according to the invention is the fact that it is possible to show on the display of the positioning device simultaneously as graphical symbols a number of objects to be positioned inputted into the positioning device, regardless of whether the positioning device is in the map display mode or the arrow display mode. The number of the objects shown can be selected by the user of the positioning device. The objects to be positioned are shown on the display of the positioning device preferably as icons.

In a preferred embodiment of the invention, the icons are provided with a shortcut menu for presenting and editing information related to the objects to be positioned and/or for performing measures related to the object to be positioned. The shortcut menu is preferably opened by moving the cursor of the positioning device onto the icon and clicking the icon.

In another preferred embodiment of the invention, the icons representing the objects to be positioned are placed on the compass circle in the arrow display mode so that their location on the compass circle indicates in which direction the object to be positioned is in relation to the positioning device.

In a third preferred embodiment of the invention, in the arrow display mode the direction arrow indicates the active object to be positioned, and information related to the active object to be positioned is shown on the display in the primary data field. Information related to other objects to be positioned is preferably shown on the display in the secondary data field. There can be one or more primary and secondary data fields.

In a fourth preferred embodiment of the invention, the icons representing the objects to be positioned are shown on the map base in the map display mode when they are located on the part of the map base visible on the display, and on the edges of the map base when they are located outside the part of the map base visible on the display. Preferably, the icons representing objects outside the part of the map base are placed on the edges of the map base in a way that they indicate in which direction the object to be positioned associated with the icon is in relation to the location of the positioning device. The appearance of the icon is preferably changed when the icon is placed on the edge of the map base.

The invention has the advantage that it makes it easier to track a number of objects to be positioned simultaneously, because all the objects inputted into the positioning device or those selected by the user are simultaneously visible on the display of the positioning device. Due to the possibility of selection provided for the user, the number of the objects shown simultaneously can be chosen such that it is possible to distinguish the objects from each other.

Furthermore, the invention has the advantage that using the positioning device is quicker, because fewer measures performed with the menu or the keyboard are required.

In the following, the invention will be described in detail. Reference will be made to the accompanying drawings, in which

### BRIEF DESCRIPTION OF THE DRAWINGS

FIGS. 1a-1d show an example of a positioning device according to the invention in the map display mode, and

FIG. 2 shows an example of the display of a positioning device according to the invention in the arrow display mode.

### DETAILED DESCRIPTION OF THE PREFERRED EMBODIMENTS

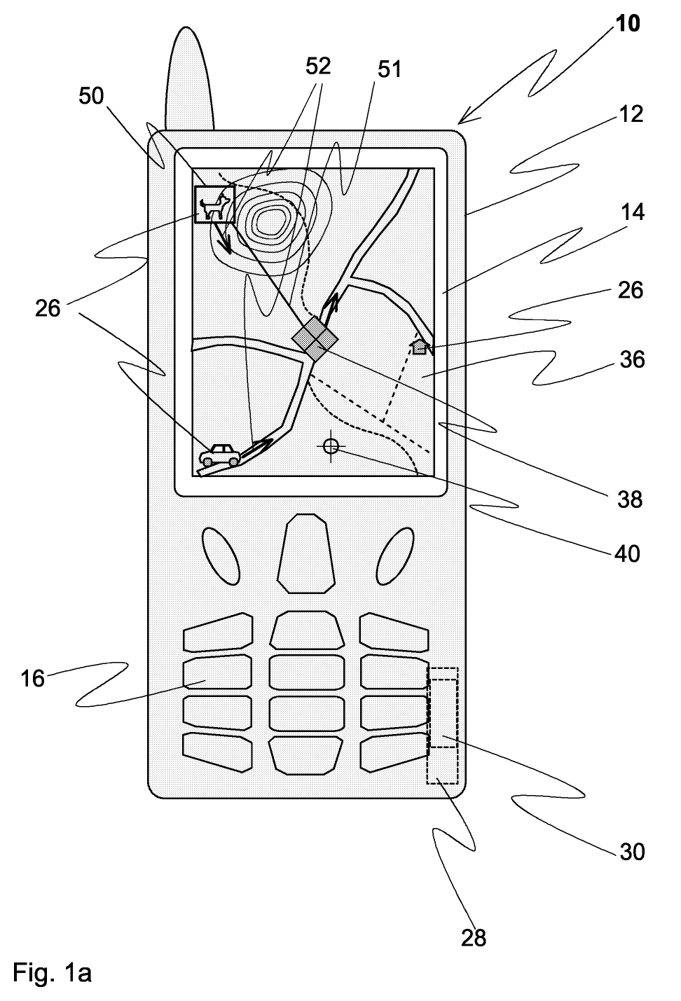

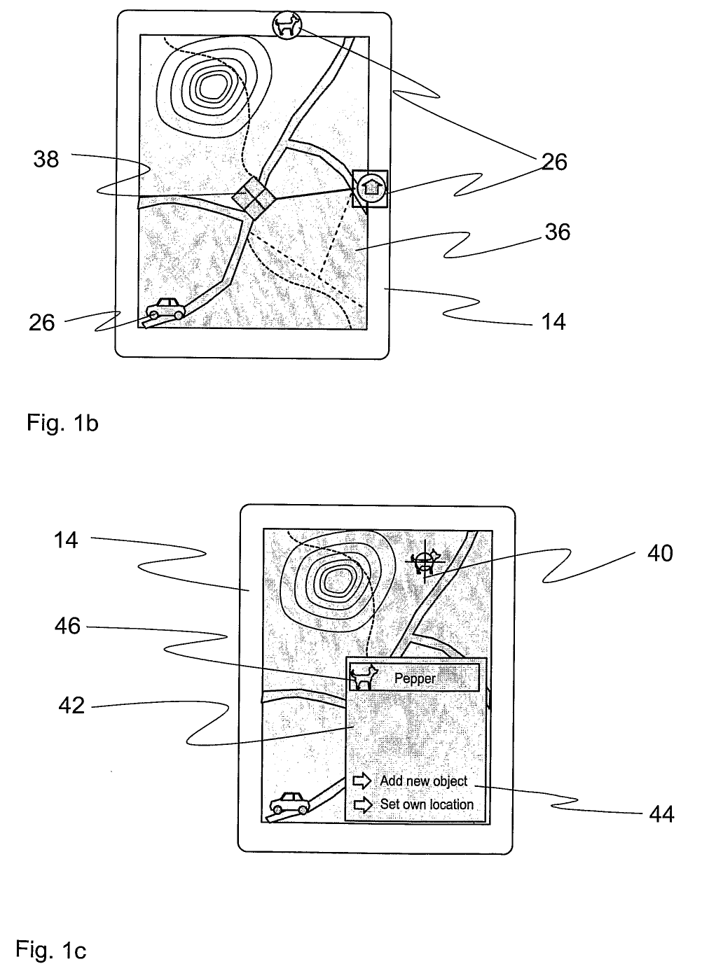

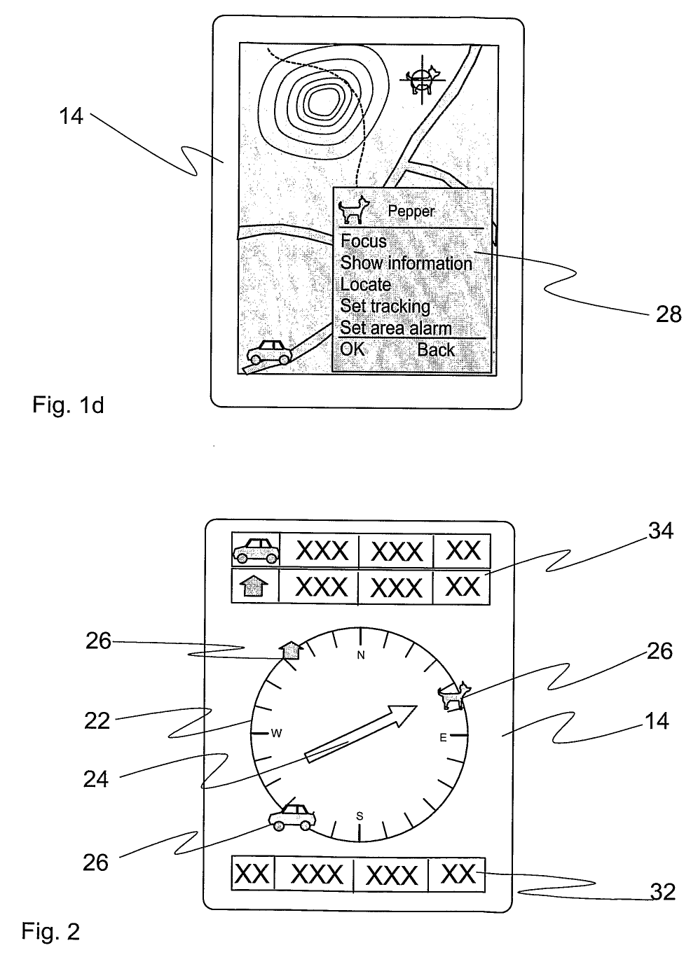

FIG. 1a shows an example of a portable positioning device 10 according to the invention as seen from the front. The positioning device has a casing 12, within which the electronic parts and components of the positioning device, such as the memory 28, have been placed. An application program according to the invention, which controls the operations of the device and by which the operations of the method according to the invention are implemented in the positioning device, has been loaded into the memory. On one side of the casing there is a display 14 for presenting information and a keyboard 16 for inputting information. The display can be either a conventional display or a so-called touch-screen display, in which the operations of the device can be controlled by touching the objects visible on the display. The positioning device according to the invention is a satellite positioning device, i.e. it has means for receiving signals transmitted by positioning satellites and means for determining the location of the positioning device on the basis of the positioning signals received. The positioning device is preferably a so-called GPS positioning device. The positioning device preferably also has means for sending and receiving information through a wireless communications network, preferably a GSM telephone network or some other cellular telephone network. The positioning means and communications means mentioned above are of the prior art and generally used, and therefore they are not described in more detail in this context.

The positioning device according to the invention can be set in different display modes, which have been designed to serve the user of the positioning device in different situations of use. FIGS. 1a-1d show the positioning device in the first display mode, which is called the map display mode in this description. In the map display mode, there is a map base 36 on the display of the positioning device 14 of the area in which the user of the positioning device is moving. Using the map display naturally requires that a map showing the area in question has been loaded into the memory 28 of the positioning device. The location of the positioning device 10 on the map is indicated by a graphical location mark 38. The positioning device selects the map base shown on the display automatically according to the movements of the user of the positioning device so that when the positioning device is switched on, the location mark is set essentially in the centre of the display.

In a manner known as such, it is possible to input many objects to be positioned simultaneously into the positioning device according to the invention. For example, the objects to be positioned can be fixed coordinate points or moving objects, which send their own location information to the positioning device along the communications network. The moving objects are preferably other positioning devices, such as Dog-GPS devices, which are connected to the positioning device via the GSM telephone network. Fixed objects are set in the known manner so that the user moves the cursor 40 of the positioning device to the desired point on the map base and makes this point a positioning object by the menu functions of the positioning device or by a shortcut menu opened by the key functions. Moving objects to be positioned are set in the same way in principle, but the location information of moving objects is set by using the location information coordinates sent by the object itself. The location information coordinates of a moving object can be updated at desired intervals.

In connection with the setting of the objects to be positioned, an icon 26 depicting the object to be positioned is formed for each object to be positioned. An image bank 30 containing different ready-made icons saved electronically has been saved in the memory 28 of the positioning device. When the user of the positioning device sets a new object to be positioned in the positioning device, he also selects a suitable icon for the object from the image bank. The selection of the icon takes place by the menu functions of the positioning device.

In the present invention, all the objects to be positioned or the number of objects wanted by the user are shown simultaneously on the display of the positioning device, which is in the map display mode. FIG. 1a presents a situation in which the objects to be positioned are relatively close to each other, in which case all the objects to be positioned fit on the map base shown on the display. The location mark 38 indicating the location of the positioning device is seen in the middle of the display, the icon 26 (car) indicating the first object to be positioned in the lower left corner of the display, the icon (dog) indicating the second object to be positioned in the upper left corner of the display and the icon (house) indicating the third object to be positioned in the middle of the right side of the display. The active object selected by the user has been encircled by a frame 50. A line 51 indicates in which direction the active object is in relation to the positioning device. Arrows 52 indicate the direction of motion of the objects and the user's own location.

FIG. 1b shows a situation in which the objects to be positioned are so far from 20 each other that they do not fit simultaneously on the map base shown on the display 14. FIG. 1b shows only the display 14 of the positioning device. Only the location mark 38 of the positioning device and the icon 26 (car) indicating the first object to be positioned are now shown at their correct points of location on the display. The icon (dog) indicating the second object to be positioned is placed on the upper edge of the visible map base, and the icon (house) indicating the third object to be positioned is placed on the right side edge of the map. The icons placed on the edges of the map base now do not indicate the exact location of the objects to be positioned on the map, but only the direction of the object to be positioned in relation to the location mark 38 of the positioning device. When the user wants to have such an icon visible on the map, he simply rolls the map view on the display towards the icon visible on the edge until the object to be positioned appears on the visible map base. Another possibility is to move the cursor of the positioning device onto some icon on the edge and make it the focusing point of the map by the menu functions of the positioning device. The third alternative for focusing and selecting the active object is to use the shortcut keys. Some keys of the keyboard of the positioning device can be programmed as shortcut keys, whereby the pressing of such a key causes the active object to be replaced by the next object in the memory on the condition that such a function is allowed for the object. When focusing, the icon of the active object is placed in the centre of the map base and the map depicts the surroundings of this object to be positioned.

The icons 26 placed on the edges of the map base 36 visible on the display 14 thus function as auxiliary means, which help the user of the positioning device to find all the objects to be positioned from the map quickly and easily. In addition, the icons on the edges of the map base give the user a general idea of the directions in which the objects to be positioned are, even if they do not fit on the same map base. When the icons indicating the object to be positioned “drop from the map” and move to the edges of the map base, they also change their appearance. The change of the appearance of the icon can be, for example, the changing of the colour or size of the icon or some additional marking appearing in connection with the icon. The purpose of the changing of the appearance of the icon is that the user can always distinguish if the icon is near the edge of the map on the visible part of the map or on the edge of the map, in which case the object to be positioned, which is depicted by the icon, is not on the visible part of the map. In FIG. 1b, the appearance of the icons has changed so that a round edge has appeared around them. If the icon located on the edge of the map base has been selected as the active object, there is a frame 50 around it, and a line 51 indicating the direction connects the icon and the location mark 38.

In a preferred embodiment of the invention, the icons 26 have been arranged to function as shortcut icons so that clicking the icon opens a separate shortcut menu 42 on the display, by which the user can perform operations on the selected object or look at the information of the object. FIGS. 1c and 1d present a series of images, which illustrates the shortcut menu property associated with the icons. Only the display 14 of the positioning device is shown in the images. When the user wants to use the shortcut menu 42, he moves the cursor 40 of the positioning device onto the icon 26 visible on the display 14 and clicks the icon, i.e. performs a predetermined key function on the keyboard of the positioning device. The icon can be on the visible part of the map base or on the edge of the map. The selection of the icon opens a shortcut menu 42 on the display, presenting a list of the measures that can be performed on the object or place indicated by the icon. If the icon represents an object to be positioned, there is at least one object function line 46 in the shortcut menu. The object function line shows at least the image of the icon selected by the cursor and the name of the object to be positioned associated with the icon (FIG. 1c). If there are many icons on top of each other at the same point indicated by the cursor, there are many object function lines in the shortcut menu opened, one for each icon and the object to be positioned associated with it. If the cursor is on the map base during selection (and not on the icon on the edge of the map), location function lines 44 also appear in the opening shortcut menu, by which the user can perform functions related to the map point indicated by the cursor, such as setting the map point as the new object to be positioned.

When the shortcut menu 42 has opened on the display, the user selects the 10 desired object function line 46 or location function line 44 from it by the cursor or the menu rolling functions. The selected line is seen in the menu as framed. Clicking the location function line causes the performance of the function mentioned on the line, such as adding a new object. If the user clicks some object function line, a submenu 28 related to the object opens, providing the possibility of performing various functions related to the object. The number of possible functions to be performed depends on the type of this object. FIG. 1 d shows an example of a submenu 28 of a shortcut menu, in which the object to be positioned is a moving object equipped with its own GPS positioning device, preferably a so-called Dog-GPS device having a wireless communication connection to the user's positioning device. The functions mentioned in the submenu shown in FIG. 1d can be performed on the moving object in question.

FIG. 2 shows the positioning device presented in FIGS. 1a-1d in the second display mode, which is called the arrow display mode in this description. FIG. 2 shows only the display 14 of the positioning device. The positioning device according to the invention is set in the arrow display mode by a predetermined key of the keyboard 16 or by the menu functions of the device. In the arrow display mode, a compass circle 22 with a direction arrow 24 in the middle is seen on the display 14 of the positioning device. The direction arrow indicates the object which the user has set as the active “main object”, i.e. the object to which the user wants to have guidance by the direction arrow. In the present invention, in addition to the main object, all other objects inputted into the positioning device and to be positioned or the ones wanted by the user are simultaneously shown on the display of the positioning device, when the positioning device is in the arrow display mode. The icons depicting other objects to be positioned are placed on the edges of the compass circle 22 at the points which indicate their direction in relation to the positioning device. On the lower edge of the display there is a primary data field 32, in which various pieces of information of each active object are shown as numerical values. Such information can be, for example, the distance to the active object, the moving speed towards the active object and the estimated time of arrival at the active object. There may be more than one primary data fields. The user can change the active object by the menu functions of the positioning device. The user can also move the cursor onto the icon 26 of the desired object and click it, whereby a shortcut menu opens on the display, and a new, active object can be set quickly by the menu.

In a preferred embodiment of the invention, the icons depicting the objects to be positioned are placed on the compass circle so that the distance between the icon and the midpoint of the compass circle is proportional to the distance between the object to be positioned, which is depicted by the icon, and the positioning device. The icons of objects to be positioned near the positioning device are thus placed closer to the midpoint of the compass circle than the icons of objects further from the positioning device. If the distance of the objects to be positioned from the positioning device changes, the location of the icons on the compass circle naturally changes correspondingly. The icons are preferably placed on the compass circle as stepped according to the distance between the object to be positioned and the positioning device. Stepped placement means that the icons are placed on the outer circle of the compass circle when the distance between the object to be positioned and the positioning device is longer than the set threshold value, and correspondingly in the area between the outer circle and the midpoint of the compass circle, when the distance between the object to be positioned and the positioning device is shorter than the set threshold value. The set threshold could be 3 kilometers, for example. It is also possible to set a number of thresholds for the distance between the object to be positioned and the positioning device, in which case a certain distance of the icon from the midpoint of the compass circle corresponds to each area between the thresholds.

In a preferred embodiment of the invention, there is a secondary data field 34 on 30 the upper edge of the display. In this data field, it is possible to show a list of the icons of all the objects to be positioned, the distances from the positioning device and possibly some other information about the objects. Using the secondary data field requires that the display 14 of the positioning device is sufficiently large so that it can be shown on the display simultaneously with the compass circle and the first data field. The secondary data field has preferably a rolling function, whereby only a part of the whole content of the data field can be shown on the visible part of the data field, and the desired point of the data field can be “rolled” to become visible by the rolling functions. Rolling can also take place automatically as timed, in such a way, for example, that one piece of information is visible for two seconds, after which the next piece of information is shown. There can also be more than one secondary data fields.

The method according to the invention for presenting objects to be positioned on the display of the positioning device is implemented by means of an application loaded into the memory of the positioning device. The application can be saved as a separate computer program in the storage medium, from which it can be loaded into the memory of the positioning device. The application can also be loaded into the positioning device through a wired or wireless communications network, such as the GPRS network.

In the above description, the positioning device includes an integrated satellite signal receiver. The satellite signal receiver can also be a separate part, which has a communications connection to a mobile terminal device equipped with a positioning application. The data transfer connection can be a Bluetooth connection, for example. A positioning device then means a unit consisting of a receiver, a terminal device and an application. The terminal device can be, for example, a palm computer, a portable computer or preferably a mobile phone. In a preferred embodiment of the invention, the terminal device has no internal or external satellite signal receiver for determining the location of the terminal device itself. In these solutions, the user indicates his location by means of a map shown on the display.

Some preferred embodiments of the method, positioning device and application according to the invention have been described above. The invention is not limited to the above described solutions only, but the inventive idea can be applied in numerous ways within the scope defined by the claims.

1. A method for showing the objects to be positioned as graphical symbols, such as icons, on the display of a mobile positioning device, which can be set in a map display mode, in which there is a map base visible on the display and in an arrow display mode, in which there is a compass circle and a direction arrow visible on the display, characterized in that in the map display mode, the graphical symbols representing the objects to be positioned are shown on the map base when they are located on the part of the map base visible on the display, and on the edges of the map base when they are located outside the part of the map base visible on the display.

2. A method according to claim 1, characterized in that in the map display mode, the icons representing the objects outside the part of the map base visible on the display are placed on the edges of the map base in a way that they indicate in which direction the object to be positioned associated with the icon is in relation to the location of the positioning device.

3. A method according to claim 1, characterized in that the appearance of the icon is changed when the icon is placed on the edge of the map base.

4. A method according to claim 1, characterized in that the icons are provided with a shortcut menu for presenting and editing information related to the objects to be positioned and/or for performing functions related to the object to be positioned.

5. A method according to claim 4, characterized in that the shortcut menu is opened by moving the cursor of the positioning device onto the icon and clicking the icon.

6. A method according to claim 1, characterized in that in the arrow display mode, the icons depicting the objects to be positioned are placed on the compass circle in a way that their location on the compass circle indicates in which direction the object to be positioned is in relation to the positioning device.

7. A method according to claim 6, characterized in that the icons depicting the objects to be positioned are placed on the compass circle in a way that the distance between the icon and the midpoint of the compass circle is proportional to the distance between the object to be positioned depicted by the icon and the positioning device.

8. A method according to claim 6, characterized in that in the arrow display mode, the direction arrow points to the icon depicting the active object and that information related to the active object is shown on the display in the primary data field.

9. A method according to claim 8, characterized n that in the arrow display mode, information related to other objects than the object to be positioned and indicated by the direction arrow is presented on the display in the secondary data field.

10. A mobile positioning device having a display for presenting information and means for presenting the objects to be positioned as graphical symbols, such as icons, on the display of the positioning device, which positioning device can be set in a map display mode, in which there is a map base visible on the display and in an arrow display mode, in which there is a compass circle and a direction arrow visible on the display, characterized in that in the map display mode, the icons representing the objects to be positioned are arranged to be placed on the map base when they are located on the part of the map base visible on the display, and on the edges of the map base when they are located outside the part of the map base visible on the display.

11. A positioning device according to claim 10, characterized in that in the map display mode, the icons representing objects outside the part of the map base visible on the display are arranged to be placed on the edges of the map base in a way that they indicate n which direction the object to be positioned, represented by the icon, is in relation to the location of the positioning device.

12. A positioning device according to claim 10, characterized in that it comprises a memory having an image bank for the icons.

13. A positioning device according to claim 10, characterized in that the icons are provided with a shortcut menu, which is arranged to open by selecting the icon, preferably by moving the cursor of the positioning device onto the icon and clicking the icon.

14. A positioning device according to claim 13, characterized in that there is at least one object function line in the shortcut menu for presenting and/or editing information of the object to be positioned, associated with the icon.

15. A positioning device according to claim 14, characterized in that the object function line is provided with a submenu, which is arranged to open by selecting the object function line, and which submenu comprises alternative functions to be performed on the object to be positioned.

16. A positioning device according to claim 13, characterized in that there is at least one location function line in the shortcut menu for performing the functions related to the coordinate point of the map base pointed by the Cursor.

17. A positioning device according to claim 10, characterized in that in the arrow display mode, the icons depicting the objects to be positioned are arranged to be placed on the compass circle in a way that their location on the compass circle indicates in which direction the object to be positioned is in relation to the positioning device.

18. A positioning device according to claim 17, characterized in that the icons depicting the objects to be positioned are arranged to be placed on the compass circle so that the distance between the icon and the midpoint of the compass circle is proportional to the distance between the object to be positioned depicted by the icon and the positioning device.

19. A positioning device according to claim 17, characterized in that in the arrow display mode, the direction arrow is arranged to point to the icon depicting the active object, and that there is at least one primary data field on the display for presenting information related to the active object.

20. A positioning device according to claim 17, characterized in that in the arrow display mode, there is at least one secondary data field on the display for presenting information of other objects than the object indicated by the direction arrow.

21. A positioning device according to claim 10, characterized in that it has means for sending and receiving positioning information via a wireless communications network, preferably a cellular telephone network.

22. A positioning device according to claim 10, characterized in that it has means for receiving and processing of signals transmitted by positioning satellites.

23. A positioning device according to claim 22, characterized in that it has means for determining the location of the positioning device on the basis of the positioning signals received.

24. A positioning device according to claim 22, characterized in that it is a so-called GPS positioning device.

25. A positioning device according to claim 22, characterized in that it comprises a separate locator with said means for receiving and processing of signals transmitted by positioning satellites and a separate terminal device equipped with a positioning application, and that there is a data transfer connection between the locator and the terminal device, preferably a Bluetooth connection.

26. A positioning device according to claim 25, characterized in that said terminal device is a portable computer, a palm computer or a mobile phone.

27. An application for presenting objects to be positioned as graphical symbols, such as icons on the display of a mobile positioning device, which positioning device can be set in a map display mode, in which there is a map base visible on the display and an arrow display mode, in which there is a compass circle and a direction arrow visible on the display, characterized in that said application comprises means for placing icons depicting the objects to be positioned on the map base in the map display mode when they are located on the part of the map base visible on the display and on the edges of the map base when they are located outside the part of the map base visible on the display.

28. An application according to claim 27, characterized in that it comprises means for placing icons depicting objects to be positioned on the edges of the map base in the map display mode in a way that they indicate in which direction the object to be positioned associated with the icon is in relation to the location of the positioning device.

29. An application according to claim 27, characterized in that it comprises means for placing icons depicting the objects to be positioned on the compass circle in the arrow display mode in a way that their location on the compass circle indicates in which direction the object to be positioned is in relation to the positioning device.

30. An application according to claim 29, characterized in that the icons depicting the objects to be positioned are arranged to be placed on the compass circle in such a way that the distance between the icon and the midpoint of the compass circle is proportional to the distance between the object to be positioned, depicted by the icon, and the positioning device.

31. An application according to claim 27, characterized in that it comprises means for indicating the direction of motion of the moving object on the map base visible on the display in the map display mode.

32. An application according to claim 27, characterized in that it comprises means for emphasizing the selected, active object, and means for indicating the direction of the active object in the map display mode.

33. A computer program on a storage or data transfer medium for loading an application according to claim 27 into the memory of the mobile positioning device for implementing the method according to claim 1.
